(19) United States
(12) Patent Application Publication
(10) Pub. No.: US 2009/0162122 A1
(43) Pub. Date: Jun. 25, 2009

(54) Image forming apparatus

(75) Inventors: Atsushi Roppongi, Ibaraki-ken (JP); Tatsunori Kaneko, Ibaraki-ken (JP); Masashi Hara, Ibaraki-ken (JP)

Correspondence Address: THE NATH LAW GROUP, 112 South West Street, Alexandria, VA, 22314, US

(73) Assignee: RISO KAGAKU CORPORATION, Tokyo (JP)

(21) Appl. No.: 12/314,476

(22) Filed: Dec. 11, 2008

(30) Foreign Application Priority Data
Dec. 21, 2007 (JP) 2007-330865

(51) Int. Cl. G03G 15/00

(52) U.S. Cl. 399/401

(57) ABSTRACT

An image forming apparatus capable of performing a double-side printing process is described. The transportation efficiency and the productivity can be improved by narrowing the distance between adjacent print sheets for use in absorbing the disparity in the transportation of print sheets. The image forming apparatus includes a switchback route which is connected to a circulating transportation route CR as a branch, receives a print sheet from the circulating transportation route CR, moves the print sheet backwards and forwards, and return the print sheet to the circulating transportation route CR in order to reverse the print sheet; a scheduling unit 201 for determining the schedule of transporting the print sheets through the circulating transportation route CR and the switchback route SR; a monitoring unit 203 for monitoring the transportation position of the print sheet along the circulating transportation route CR or the switchback route SR; and a reversing route control unit 204b for controlling the stay time of the print sheet in the switchback route SR on the basis of the transportation schedule determined by the scheduling unit 201 with reference to the transportation position monitored by the monitoring unit 203.

### BACKGROUND OF THE INVENTION

1. Field of the Invention

The present invention relates generally to an image forming apparatus for transporting a print sheet on a circulating transportation route in which an image is formed on the print sheet, and more particular to an image forming apparatus provided with a reversing route which is connected to the circulating transportation route as a branch.

2. Description of the Background Art

In recent years, many image forming apparatus such as ink jet printers are provided with the capability of printing images on the both sides of paper. For example, as shown in Japanese Patent Published Application No. 2006-264828, after printing an image on one side of a print sheet, the print sheet is transferred to a reversing transfer route in which the print sheet is turned over to switch the side to be printed, followed by printing an image on the other side.

Incidentally, in the case of this prior art image forming apparatus, some difference occurs between the designed transfer operation and the actual transfer operation due to some misalignment occurring during operation of the transfer mechanism, the environmental conditions, the type of paper and so forth. Because of the difference, an timing error may occur in printing operation. The timing error is absorbed by adjusting the printing timing on the basis of the misalignment in the transfer operation which is detected by a sensor or the like, so that the misalignment can be permitted in a tolerable range.

However, while the printing misalignment can be corrected by adjusting the printing timing, the misalignment in the position of the print sheet cannot be corrected. The tolerable range of the misalignment which can be corrected by the printing timing adjustment is determined by the distance between adjacent sheets. In order to enlarge the tolerable range of the misalignment, it is necessary to set the distance between adjacent sheets wider. The productivity is compromised by the wider distance which lowers the transportation efficiency.

### SUMMARY OF THE INVENTION

Taking into consideration the above circumstances, it is an object of the present invention to provide an image forming apparatus capable of performing a double-side printing process in which the process of printing on one sides of print sheets is performed in parallel with the process of printing on the other sides wherein it is possible to improve the efficiency of transportation and the productivity by narrowing the distance between adjacent print sheets for use in absorbing the disparity in the transportation of print sheets.

In order to accomplish the object as described above, an image forming apparatus of the present invention is provided for forming an image on a sheet which is transported along a circulating transportation route which is provided in a loop-like form, and comprises: a reversing route connected to the circulating transportation route as a branch, and operable to receive a sheet from the circulating transportation route, move the print sheet backwards and forwards, and return the print sheet to the circulating transportation route CR in order to reverse the print sheet; a scheduling unit operable to determine a transportation schedule for transporting the sheet along the circulating transportation route and the reversing route; a monitoring unit for monitoring the transportation position of the sheet along the circulating transportation route and the reversing route; and a reversal control unit operable to control the stay time of the sheet in the reversing route on the basis of the transportation schedule determined by the scheduling unit and the transportation position monitored by the monitoring unit.

It is preferred in the above invention that the stay time of the sheet is controlled by changing the transportation speed of the sheet in the reversing route.

In accordance with the present invention as described above, misalignment of paper transportation along the circulating transportation route can be corrected by acquiring the actual transportation status through the monitoring unit, detecting the difference between the actual measured time and the theoretical time of the transportation schedule on a real time base, and shortening or prolonging the stay time in the switchback route SR to correct the difference.

Meanwhile, the scheduling unit of the present invention as described above may determine the transportation schedule in order that, during a double-side printing process, a print sheet is reversed by transferring this print sheet from the circulating transportation route to the reversing route and vice versa, and inserted between subsequent print sheets, which are transported on the circulating transportation route for printing on the main sides thereof, in order that the process of printing on one sides of print sheets is performed in parallel with the process of printing on the other sides. In this case, the process of printing on one sides can be performed in parallel with the process of printing on the other sides in the double-side printing mode and, as compared with the conventional process in which the back side is printed only after the main side has been printed, the print time can substantially be reduced, resulting in higher printing capability (higher productivity).

In accordance with the present invention, the image forming apparatus is capable of performing the process of printing on one sides of print sheets in parallel with the process of printing on the other sides and adjusting the disparity between the scheduled transportation position and the actually detected transportation position, and therefore it is possible to narrow the distance between adjacent print sheets for use in absorbing the disparity in the transportation of print sheets, and improve the efficiency of transportation and the productivity.

### BRIEF DESCRIPTION OF THE DRAWINGS

The objects and features of the present invention will become more apparent from consideration of the following detailed description taken in conjunction with the accompanying drawings in which:

FIG. 1 is a view for schematically showing the configuration of an image forming apparatus in accordance with an embodiment.

FIG. 2 is a view for schematically showing the transportation routes in the image forming apparatus in accordance with the embodiment.

FIG. 3 is a block diagram for showing function modules for realizing the misalignment correction process of an arithmetic operation unit of the image forming apparatus in accordance with the embodiment.

FIG. 4A and FIG. 4B are flow charts for showing the procedure of the misalignment correction process of the image forming apparatus in accordance with the embodiment.

### DESCRIPTION OF THE PREFERRED EMBODIMENTS

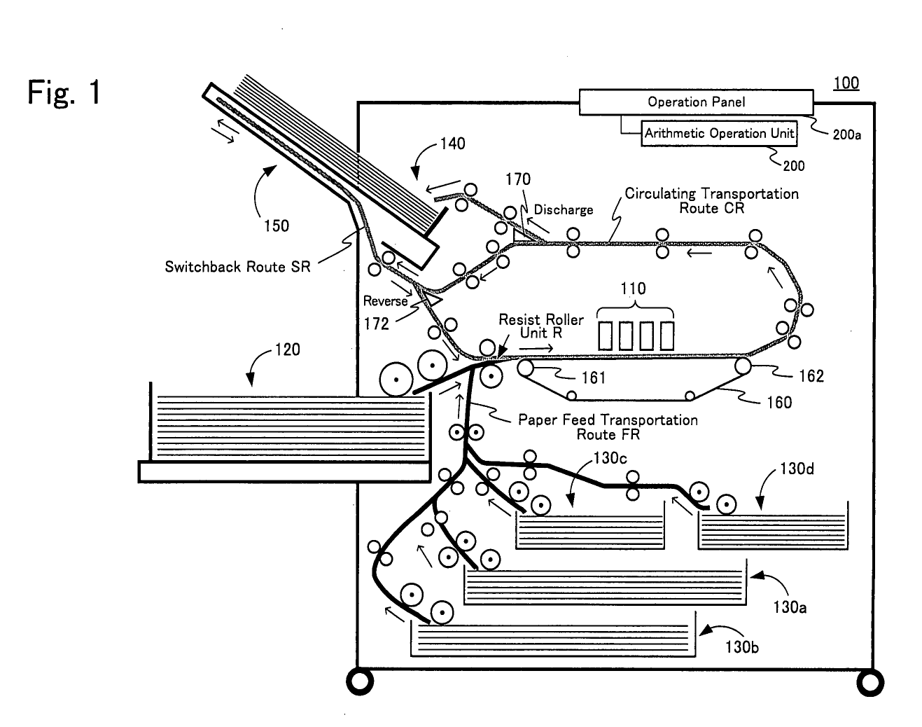

In the following description, an embodiment of the present invention will be explained in conjunction with the accompanying drawings. FIG. 1 is a view for schematically showing the configuration of the image forming apparatus in accordance with the present invention.

First, the image forming apparatus 100 shown in FIG. 1 is provided with a paper feed mechanism for feeding print sheets including a paper feed side tray 120 exposed from the side surface of the housing of the image forming apparatus 100, a plurality of paper feed trays 130a, 130b, 130c and 130d which are located inside the housing. Furthermore, a discharge port 140 is provided as a discharge mechanism for discharging print sheets which have been printed.

In the case of the present embodiment, the image forming apparatus 100 is a line color inkjet printer provided with a plurality of ink heads 110 each of which is elongated in the width direction of the print sheet. The respective ink heads 110 eject black or color inks respectively in order to print images of the respective colors on a line-by-line basis to overlap each other.

A print sheet fed from either the paper feed side tray 120 or one of the paper feed trays 130 is transported along a paper feed transportation route FR by rollers or another transportation mechanism to a resist roller unit R which defines a reference position at which the leading edge of each print sheet is aligned. The head units 110 having a plurality of print heads are located in the downstream side of the paper feed transportation route FR as seen from the resist roller unit R. The print sheet is printed to form an image with ink ejected from the respective print heads on a line-by-line basis, while being transported at a predetermined speed on a conveyor belt 160 which is located on the opposite side to the print heads 110.

The print sheet which has been printed is transported in the housing by the transportation mechanism such as rollers. In the case of the one-side printing for printing only one side of the print sheet, the print sheet is transferred to the discharge port 140 and stacked on a catch tray 150 as a receiver at the discharge port 140 with the printed side down. The catch tray 150 is provided to protrude from the housing with a certain thickness. The catch tray 150 is slanted with a lower upright wall at which print sheets discharged from the discharge port 140 are automatically aligned under their own weight.

In the case of the double-side printing for printing both sides of the print sheet, the print sheet is not transferred to the discharge port 140 when printing the main side (the first printed side is called “main side”, and the next printed side is called “back side” in this description), but is transported in the housing and supplied to a switchback route SR. This switchback route SR is a reversing route which is connected to a circulating transportation route CR as a branch, receives the print sheet from the circulating transportation route CR, moves the print sheet backwards and forwards (switchback motion), and return the print sheet to the circulating transportation route CR in order to reverse the print sheet. The image forming apparatus 100 is provided with a shunt mechanism 170 for selectively switching the route between the discharging route DR and the switchback route SR such that the print sheet is guided to enter this switchback route SR for double-side printing. In the double-side printing mode, the shunt mechanism 170 transfers the print sheet to the switchback route SR, rather than the discharging route DR, such that the print sheet is reversed with respect to the transportation route by the switchback operation.

The print sheet is transferred to the resist roller unit R again by the transportation mechanism such as rollers through a switching mechanism 172, and printed on the back side in the same manner as on the main side. After printing on the back side, the print sheet with images printed on the both sides is transferred to the discharge port 140, and stacked on the catch tray 150 as the receiver at the discharge port 140.

Incidentally, in the case of the present embodiment, the switchback operation is performed by the use of the space formed inside the catch tray 150 in the double-side printing mode. The space formed in the catch tray 150 is provided such that the print sheet cannot be accessed externally during the switchback operation. By this configuration, it is avoided that a user extracts the print sheet during the switchback operation by mistake. On the other hand, since the catch tray 150 is indispensable for the image forming apparatus 100, there is no need for a separate space, which is particularly provided in the image forming apparatus 100 for the switchback operation, while making use of the space formed in the catch tray 150 for the switchback operation. Accordingly, it is possible to prevent the size of the housing from increasing for the purpose of implementing the switchback operation. Furthermore, since the discharge port and the switchback route SR are separated, the paper discharge operation can be performed in parallel with the switchback operation.

In the double-side printing mode, the print sheet is transferred to the resist roller unit R, which defines the reference position at which the leading edge of the print sheet is aligned, not only before printing one side thereof but also before printing the other side. Because of this, just before the resist roller unit R, there is a junction point between the transportation route for the print sheet just fed and the transportation route for the print sheet having one printed side.

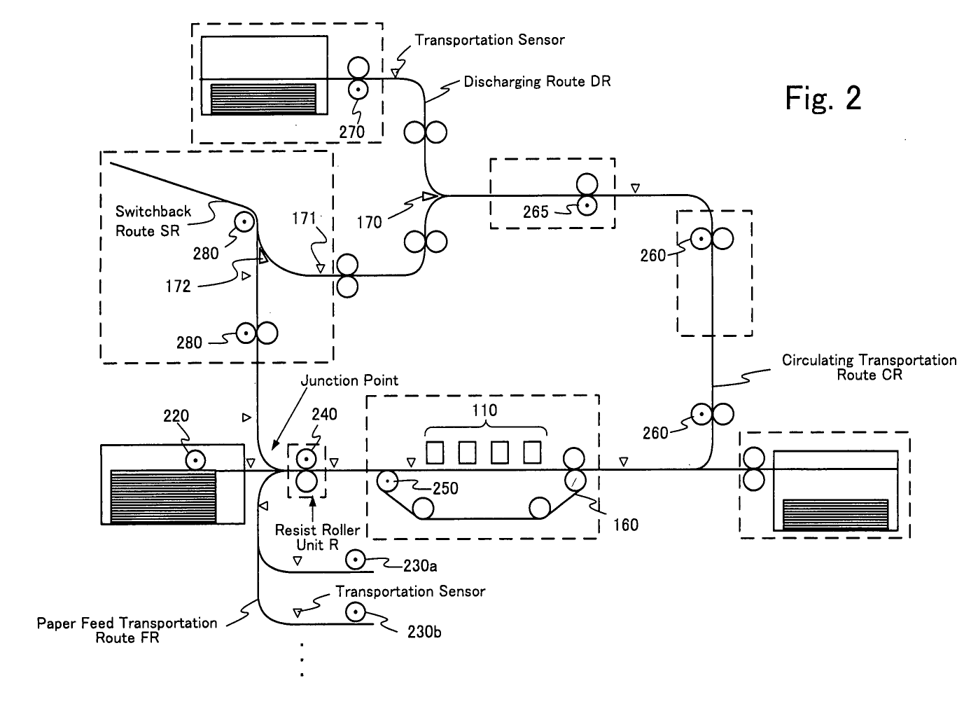

The paper transportation route is divided into the paper feed transportation route FR, which is located on the paper feed mechanism side as seen from this junction point, and the remaining circulating transportation route CR. FIG. 2 is a diagram for schematically showing the paper feed transportation route FR and the circulating transportation route CR. Some of rollers forming the transportation mechanism are not illustrated in FIG. 2 for the sake of clarity in explanation.

The paper feed transportation route FR is provided with a side feed transportation unit 220 for feeding paper from the paper feed side tray 120, a first tray feed transportation unit 230a, a second tray feed transportation unit 230b, . . . respectively for feeding paper from the paper feed trays 130a, 130b, 130c and 130d. Each transportation unit comprises a transportation mechanism constructed by a plurality of rollers to extract print sheets one after another from the paper feed tray corresponding thereto and transfer the print sheets to the resist roller unit R. The respective transportation units can be driven independently from each other, and perform necessary operation in order to implement the paper feed mechanism.

In addition, the paper feed transportation route FR is provided with a plurality of transportation sensors with which paper jam can be detected along the paper feed transportation route FR. Each transportation sensor is a sensor which can determine if a print sheet is present and detect the leading edge of the print sheet. For example, the plurality of transportation sensors are located on the paper feed transportation route at appropriate intervals. Paper jam can be detected if the transportation sensor located on the transportation side does not detect the print sheet a predetermined time after the transportation sensor located on the paper feeding side detects the print sheet. Furthermore, paper jam (paper feeding error) can also be detected if the transportation sensor located near the paper feed tray does not detect the print sheet a predetermined time after starting driving the side feed transportation unit 220, the first tray feed transportation unit 230a or the like.

By providing the transportation sensor 130 near each paper feed tray, it is possible to determine whether or not paper jam occurs in the paper feed transportation route FR, and determine in what location of the paper feed transportation route FR the paper jam occurs.

Along the circulating transportation route CR, there are a resist drive unit 240 for receiving a print sheet at the resist roller unit R, a belt drive unit 250 for driving the conveyor belt 160, which is located in a position opposite the head units 110, in an endless motion, first and second upper side paper transportation units 260 and 265 which are arranged on the circulating transportation route CR successively in the paper transportation direction, an upper side paper discharge transportation unit 270 for transferring a printed sheet to the discharge port 140, and a switchback route transportation unit 280 for drawing the printed sheet in the switchback route SR, reversing and transferring the printed sheet to the junction point between the circulating transportation route CR and the paper feed transportation route. Each of these transportation units is provided with a driving mechanism comprising one or more rollers, and serves to transport print sheets one after another along the transportation route. The respective transportation units can be driven independently from each other, and perform necessary operation in accordance with the transportation position of the print sheet.

The circulating transportation route CR is also provided with a plurality of transportation sensors with which paper jam can be detected along the circulating transportation route CR. Furthermore, it can be confirmed that each print sheet is transferred to the resist roller unit R in an appropriate manner. A transportation sensor is provided near each transportation unit, and thereby it is possible to determine in what location of the circulating transportation route CR the paper jam occurs.

Meanwhile, in the case of the present embodiment, a print sheet is fed to the image forming apparatus 100 in advance of discharging the preceding print sheet, without waiting until the preceding print sheet is discharged, so that print sheets are successively fed and continuously printed.

The conveyor belt 160 is located between and running around a driving roller 161 and driven rollers 162 located in a position opposite the head units 110, and rotates about them in the clockwise direction as seen in the figure. Four ink heads 110 of yellow (Y), magenta (M), cyan (C), and black (K) are arranged over the upper surface of the conveyor belt 160 along the moving direction thereof, and located opposite the conveyor belt 160 to form a color image by superimposing four monochromatic images.

Meanwhile, as shown in FIG. 1, the image forming apparatus 100 is provided with an arithmetic operation unit 200. This arithmetic operation unit 200 is an operation module composed of hardware such as a CPU, a memory, electronic circuits and the like, and software (and firmware) for implementing necessary functions in combination with the hardware. Several function modules can be implemented by the software for performing the processes of handling image data, controlling the operations of the respective units, and performing a variety of processes in response to the manipulation by the user. In addition, this arithmetic operation unit 200 is connected to an operation panel 200a, through which the arithmetic operation unit 200 can receive commands and settings from the user.

The arithmetic operation unit 200 performs the misalignment correction process in accordance with the present embodiment by controlling the operations of the head units 110, the respective drive motors, the respective switching mechanism and other elements for implementing the transportation mechanism.

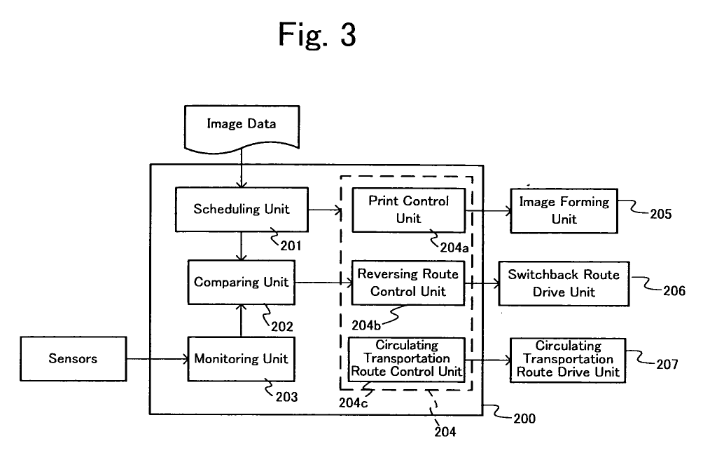

FIG. 3 is a block diagram for showing function modules for realizing the misalignment correction process of the arithmetic operation unit 200. As shown in FIG. 3, the function module includes a scheduling unit 201, a comparing unit 202, a monitoring unit 203 and an image formation control unit 204.

The scheduling unit 201 is a module for analyzing job data, detecting the size and number of print sheets to be printed, determining whether or not the double-side printing is selected, and providing the schedule of transporting the print sheets through the circulating transportation route CR and the switchback route SR on the basis of the result of determination.

This transportation schedule is a time schedule for defining the timing of feeding and discharging each print sheet, the timing and order of printing images by an image forming unit 205, the transportation speeds of each print sheet along the circulating transportation route CR and the switchback route SR, and the timing of switching operation by the switching mechanism. In accordance with the time schedule, after printing the main side of a print sheet, the print sheet is reversed and returned to the circulating transportation route CR in order to insert the print sheet into the circulating transportation route CR between subsequent print sheets which are fed to the circulating transportation route CR. Particularly, when a print sheet is printed, this transportation schedule is used to set the timing of feeding paper and the transportation speeds or accelerations along the respective transportation routes on the basis of the sheet size, the amount of print material contained in image data and the like with reference to theoretical values calculated of the time period required for transferring the print sheet from the resist roller unit R to the transportation sensor (switchback sensor) 171 provided in the switchback route SR after feeding the print sheet, and the time period required for transferring the print sheet from first reaching the resist roller unit R until returning to the resist roller unit R after circulation around the circulating transportation route CR. The transportation schedule is input to the image formation control unit 204.

The monitoring unit 203 is a module for monitoring the transportation position of a print sheet along the circulating transportation route CR or the reversing route by acquiring the detection signal output from the respective sensors, and inputting the detection signal to the comparing unit 202 as an actual measurement value. The comparing unit 202 is a module for comparing the transportation position of the print sheet acquired by the monitoring unit 203 to the transportation schedule determined by the scheduling unit 201, detecting the disparity therebetween, and inputting the detected disparity to a reversing route control unit 204b as information for correcting the misalignment of the transportation position.

The image formation control unit 204 is a module for controlling the respective units in order to print the print sheet, and provided with a print control unit 204a, a circulating transportation route control unit 204c and the reversing route control unit 204b.

The print control unit 204a is a module for temporarily accumulating image data, inputting a predetermined amount of image data to the head units 110 and printing the image data on the print sheet by the image forming unit 205 in accordance with the schedule determined by the scheduling unit 201. The reversing route control unit 204b and circulating transportation route control unit 204c serve as a module for controlling the operation of the shunt mechanisms 170 and 172 and the operation of the roller drive units located along the circulating transportation route CR and the switchback route SR, in terms of the transportation speeds along the respective transportation routes and the timing of changing the transportation route to the switchback route SR or the discharging route DR.

Particularly, the reversing route control unit 204b is a module for controlling the stay time of the print sheet in the switchback route SR on the basis of the result of comparison by the comparing unit 202. Meanwhile, the circulating transportation route control unit 204c is a module for controlling the transportation of the print sheet in the circulating transportation route CR by a circulating transportation route drive unit 207. More specifically speaking, the reversing route control unit 204b outputs a control signal to by a switchback route drive unit 206 for transporting a print sheet along the switchback route SR and transfers the print sheet to the resist roller unit R exactly corresponding to the theoretical value by the use of the result of comparison (disparity), as obtained from the comparing unit 202, between the theoretical value of the transportation schedule and the actual measured value by the monitoring unit 203 in order to correct the overrun or under run of the moving print sheet during feeding and transporting paper.

The motion control of the print sheet along the switchback route SR is to control the stay time of the print sheet in the switchback route SR by controlling the pause when reversing the transportation direction in the reversing route or the paper transportation speed in the reversing route (inclusive of the acceleration speed just after inversion, the deceleration speed for stopping just before the resist roller unit R, and so forth). For example, in the case where the actual measured time is delayed in relation to the theoretical time, the pause when reversing the transportation direction is adjusted to make up for the delay time if the delay time is no longer than the period of the pause. If the delay time is longer than the period of the pause, in addition to the adjustment of the period of the pause, the transportation speed from the switchback route SR to the resist roller unit R is also adjusted in order that the print sheet is transferred to the resist roller unit R in the time theoretically scheduled. On the other hand, in the case where the actual measured time is earlier than the theoretical time, the pause in the switchback route SR is prolonged in order that the print sheet is transferred to the resist roller unit R in the time theoretically scheduled. Incidentally, while it is possible to adjust the transportation timing by prolonging the pause in this case, the transportation speed may be adjusted in addition to this if appropriate.

(Misalignment Correction Process)

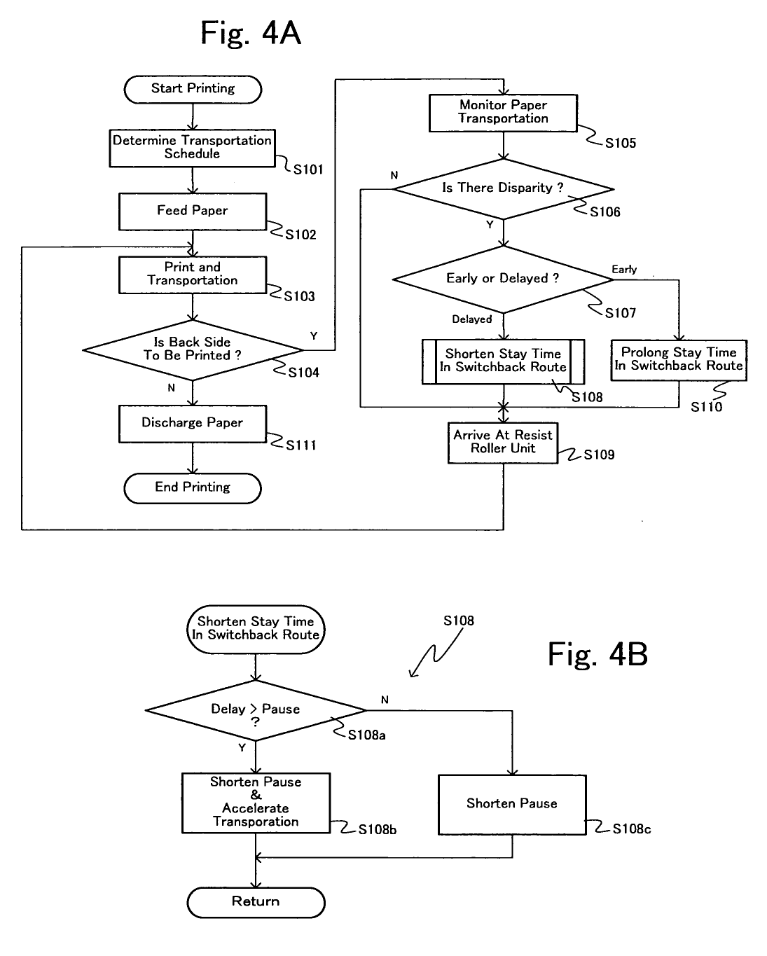

The procedure of performing misalignment correction will be explained in connection with the image forming apparatus having the structure as described above in accordance with the present embodiment. FIG. 4A and FIG. 4B are flow charts for showing the procedure of the misalignment correction process of the image forming apparatus in accordance with the present embodiment.

First, when the print process is started by receiving job data, in step S101, the scheduling unit 201 analyzes this job data, determines the size and number of print sheets to be printed and whether or not the double-side printing is selected, and providing the schedule of transporting print sheets through the circulating transportation route CR and the switchback route SR on the basis of the result of determination. This transportation schedule is input to the image formation control unit 204.

The image formation control unit 204 starts feeding paper in a predetermined timing on the basis of the transportation schedule as determined in step S102. The fed paper is printed and transferred along the circulating transportation route CR in step S103. When the print sheet having printed on the main side is transferred along the circulating transportation route CR to the branch point between the switchback route SR and the discharging route DR, the shunt mechanism 170 is driven in step S104 in accordance with whether or not to print an image on the back side.

If the back side is not to be printed (i.e., the “No” branch from step S104), the shunt mechanism 170 is switched to the discharging route DR, followed by discharging the print sheet in step S111. On the other hand, if the back side is to be printed (i.e., the “Yes” branch from step S104), the shunt mechanism 170 is switched to the switchback route SR, followed by introducing the print sheet the switchback route SR in step S111.

The switchback sensor 171 detects the print sheet in the switchback route SR, and in step S105 the monitoring unit 203 monitors the time point at which the print sheet is passed in the switchback route SR on the basis of the detection by the switchback sensor 171. The monitoring result is input to the comparing unit 202 as the actual measured value and compared with the theoretical value of the transportation schedule by the comparing unit 202 in order to determine whether or not there is a misalignment in step S106. If no misalignment occurs (i.e., the “No” branch from step S106), the print sheet is transferred through the switchback route SR by ordinary operation to the resist roller unit R in step S109, and printed on the back side in step S103, followed by discharging the print sheet in step S111.

On the other hand, if some misalignment occurs (i.e., the “Yes” branch from step S106), it is determined which type of misalignment occurs in step S107 on the basis of whether the actual measured time obtained by the monitoring unit 203 is early or delayed in relation to the theoretical time of the transportation schedule.

When the actual measured time is delayed in relation to the theoretical time (i.e., the “delay” branch from step S107), the delay time is calculated with reference to the difference therebetween, and the pause when reversing the transportation direction is adjusted in step S108c to make up for the delay time if the delay time is no longer than the period of the pause (i.e., the “No” branch from step S108a). Conversely, when the delay time is longer than the period of the pause (i.e., the “Yes” branch from step S108a), in addition to the adjustment of the period of the pause, the transportation speed from the switchback route SR to the resist roller unit R is also adjusted in order that the print sheet is transferred to the resist roller unit R in the time theoretically scheduled in step S108b.

On the other hand, in the case where the actual measured time is earlier than the theoretical time (i.e., the “early” branch from step S107), the pause in the switchback route SR is prolonged in order that the print sheet is transferred to the resist roller unit R in the time theoretically scheduled in step S110.

While the misalignment is corrected in this manner, the print sheet is transferred through the switchback route SR, reaches the resist roller unit R in the timing in accordance with the theoretical time in step S109, and printed on the back side in step S103, and discharged in step S111.

In accordance with the image forming apparatus constructed as described above, misalignment of paper transportation along the circulating transportation route CR can be corrected by acquiring the actual transportation status through the monitoring unit 203, detecting the difference between the actual measured time and the theoretical time of the transportation schedule on a real time base, and shortening or prolonging the pause in the switchback route SR to correct the difference.

Also, in accordance with the present embodiment, the scheduling unit 201 determines the transportation schedule in order that, during the double-side printing process, a print sheet is reversed by transferring this print sheet from the circulating transportation route CR to the switchback route SR and vice versa, and inserted into the circulating transportation route CR between subsequent print sheets which are transported on the circulating transportation route CR for printing on the main sides. The process of printing on the main sides can therefore be performed in parallel with the process of printing on the back sides during the double-side printing process. In comparison with the conventional process in which the back side is printed only after the main side has been printed, the print time can substantially be reduced, resulting in higher printing capability (higher productivity).

As a result, in accordance with the present embodiment, it is possible to perform the main side printing process and the back side printing process in parallel, reduce the distance between adjacent print sheets, which was relatively large in the conventional process for absorbing misalignment, and improve the efficiency of transportation and the productivity.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

What is claimed is:

1. An image forming apparatus for forming an image on a print sheet which is transported along a circulating transportation route which is provided in a loop-like form, said image forming apparatus comprising:
a reversing route connected to the circulating transportation route as a branch, and operable to receive a print sheet from the circulating transportation route, move the print sheet backwards and forwards, and return the print sheet to the circulating transportation route CR in order to reverse the print sheet;
a scheduling unit operable to determine a transportation schedule for transporting the print sheet along the circulating transportation route and the reversing route;
a monitoring unit for monitoring the transportation position of the print sheet along the circulating transportation route and/or the reversing route; and
a reversal control unit operable to control the stay time of the print sheet in the reversing route on the basis of the transportation schedule determined by the scheduling unit and the transportation position monitored by the monitoring unit.

2. The image forming apparatus as claimed in claim 1 wherein the stay time of the print sheet is controlled by changing the transportation speed of the print sheet in the reversing route.

3. The image forming apparatus as claimed in claim 1 wherein the stay time of the print sheet is controlled by changing the pause when reversing the transportation direction in the reversing route.

4. The image forming apparatus as claimed in claim 1 wherein the scheduling unit determines the transportation schedule in order that, during a double-side printing process, a print sheet is reversed by transferring this print sheet from the circulating transportation route to the reversing route and vice versa, and inserted between subsequent print sheets, which are transported on the circulating transportation route for printing on the main sides thereof, in order that the process of printing on one sides of print sheets is performed in parallel with the process of printing on the other sides.

5. The image forming apparatus as claimed in claim 1 wherein the reversing route is formed inside of a catch tray which serves to receive print sheets after forming images thereon.
